(19) United States
(12) Patent Application Publication
(10) Pub. No.: US 2004/0124238 A1
(43) Pub. Date: Jul. 1, 2004

(54) Information processing apparatus

(75) Inventors: Masaki Shimada, Tokyo (JP); Kunio Nakano, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Holdings, Inc., Tokyo (JP)

(21) Appl. No.: 10/734,489

(22) Filed: Dec. 11, 2003

(30) Foreign Application Priority Data
Dec. 18, 2002 (JP) 2002-366229

(51) Int. Cl. G06F 12/00

(52) U.S. Cl. 235/375; 711/115

(57) ABSTRACT

This invention relates to a user-friendly information processing apparatus capable of transferring electronic information from one recording medium to another recording medium while maintaining versatility of enabling connection to an external device. In this information processing apparatus, when a control unit detects that a memory card with an adaptor has been inserted in a PC card slot and allows read or write of electronic information, and an MO disk has been inserted in an MO disk slot and allows read or write of electronic information, a message that electronic information can be transferred is displayed on a monitor. The user sees the display, can grasp at a glance that electronic information can be transferred at present, and can understand that a press to a copy button starts transfer.

### BACKGROUND OF THE INVENTION

1. Field of the Invention

The present invention relates to an information processing apparatus and, more particularly, to an information processing apparatus capable of inserting/removing a plurality of recording media and transferring electronic information from one inserted recording medium to another recoding medium.

2. Description of the Prior Art

An image photographed by an electronic camera such as a digital still camera is recorded as electronic information such as an image file (to be simply referred to as a file hereinafter) on a recording medium (e.g., memory card) inserted in the camera. The recorded electronic information is transferred to a personal computer or the like and utilized. Many electronic cameras form file systems similar to one by a personal computer on recording media so as to facilitate data processing in transfer, and generally record each photographed image as one file (see Japanese Unexamined Patent Publication No. 11-164234).

Memory cards and the like put importance on portability, and most of them are formed in, e.g., a postage stamp size and generally have a small recording capacity. As an electronic camera continues photographing, the remaining recording capacity of the memory card decreases, failing in photographing in a short time. To prevent this, a file recorded on the memory card is recorded (copied) on another recording medium. The file in the memory card can be deleted, and photographing can be newly started using the same memory card.

As a general method of transferring a file in one recording medium to another recording medium, a file is read out from an electronic camera to a personal computer or the like via a USB (Universal Serial Bus) or the like, and written in another larger-capacity recording medium such as a hard disk or CD-R. This is called file backup.

To back up a file in a memory card, the user must operate a personal computer to copy the file. File backup is therefore cumbersome.

To solve this, a dedicated device which reads out a file in a memory card and writes the file in another recording medium may be prepared. The dedicated device can omit cumbersome operation, but lowers versatility and degrades the product value.

Under the present circumstance, there has been developed an information processing apparatus capable of directly transferring electronic information from one recording medium to another recording medium by one motion of pressing, e.g., a copy button without the mediacy of any external device while maintaining versatility of enabling connection to an external device such as a personal computer.

As one problem of such information processing apparatus, the user must be notified of the state of the information processing apparatus by any method in order to allow transferring electronic information without connecting the information processing apparatus to an external device such as a personal computer. In other words, electronic information is not actually transferred even by pressing a copy button unless the user confirms whether the recording medium allows read or write of information.

### SUMMARY OF THE INVENTION

The present invention has been made to overcome the conventional drawbacks, and has as its object to provide a user-friendly information processing apparatus capable of reliably transferring electronic information from one recording medium to another recording medium while maintaining versatility of enabling connection to an external device.

To achieve the above object, the first aspect of the present invention provides an information processing apparatus having a first insertion/removal portion capable of inserting/removing a first recording medium and at least reading out electronic information from the inserted first recording medium, a second insertion/removal portion capable of inserting/removing a second recording medium and reading out and writing electronic information from and in the inserted second recording medium, and an operating member which is connected to the first and second insertion/removal portions so as to be able to exchange electronic information and starts an operation of reading out electronic information recorded on the first recording medium and writing the electronic information in the second recording medium, comprising a control unit which controls exchange of electronic information in the information processing apparatus, and an expression unit which expresses an operation state of the information processing apparatus, wherein when a state in which a recording medium is inserted into at least one of the first and second insertion/removal portions and electronic information can be read out or written is detected, the expression unit performs expression operation of the state.

The user can recognize through expression operation of the expression unit that electronic information can be transferred. In accordance with this, the user operates the operating member such as a copy button to properly transfer electronic information.

To achieve the above object, the second aspect of the present invention provides an information processing apparatus having a first insertion/removal portion capable of inserting/removing a first recording medium and at least reading out electronic information from the inserted first recording medium, a second insertion/removal portion capable of inserting/removing a second recording medium and reading out and writing electronic information from and in the inserted second recording medium, and an operating member which is connected to the first and second insertion/removal portions so as to be able to exchange electronic information and starts an operation of reading out electronic information recorded on the first recording medium and writing the electronic information in the second recording medium, comprising a control unit which controls exchange of electronic information in the information processing apparatus, and an expression unit which expresses an operation state of the information processing apparatus, wherein when a state in which electronic information cannot be read out from or written in a recording medium inserted in at least one of the first and second insertion/removal portions is detected, the expression unit performs expression operation of the state.

The user can recognize through expression operation of the expression unit that electronic information cannot be transferred. In this state, even an operation to the operating member such as a copy button is apparently recognized to be invalid, resulting in a more user-friendly apparatus.

The third aspect of the present invention provides an information processing apparatus wherein the expression unit in the first and second aspects includes a display device, and the expression operation includes transfer of a visual message to a user.

The user can understand the status at a glance.

The fourth aspect of the present invention provides an information processing apparatus wherein the display device in the third aspect includes a monitor which displays a message.

Accordingly, complicated information can be transferred.

The fifth aspect of the present invention provides an information processing apparatus wherein the display device in the third and fourth aspects includes an LED.

The information processing apparatus can be preferably manufactured at low cost without any space.

The sixth aspect of the present invention provides an information processing apparatus wherein the expression unit in the first and second aspects includes a sound generating device, and the expression operation includes transfer of an auditory message to a user.

The user can receive a message-even if not gazing at the information processing apparatus.

The seventh aspect of the present invention provides an information processing apparatus wherein the sound generating device in the sixth aspect includes a loudspeaker.

The eighth aspect of the present invention provides an information processing apparatus wherein the operating member in the first aspect is operated to output to the control unit a signal for starting the operation of reading out electronic information recorded on the first recording medium and writing the electronic information in the second recording medium, and the control unit ignores the signal from the operating member until the control unit detects that a recording medium is inserted into at least one of the first and second insertion/removal portions and electronic information can be read out or written.

This suppresses transfer of improper electronic information.

The ninth aspect of the present invention provides an information processing apparatus wherein the operating member in the first aspect is operated to output to the control unit a signal for starting the operation of reading out electronic information recorded on the first recording medium and writing the electronic information in the second recording medium, and the control unit ignores the signal from the operating member after the control unit detects that a recording medium is inserted into at least one of the first and second insertion/removal portions and electronic information cannot be read out or written.

This suppresses transfer of improper electronic information.

In this specification, the first recording medium is preferably an optical information recording medium (e.g., memory card, CD-R, or DVD-R), or a magnetooptical information recording medium (e.g., MO). The second recording medium is preferably an optical information recording medium (e.g. , CD-R or DVD-R), a magnetooptical information recording medium (e.g., MO), or a hard disk. The second recording medium is preferably larger in capacity than the first recording medium. The control unit can preferably create a file system in the second recording medium by formatting or the like. The information processing apparatus preferably comprises a display unit and/or sound generating unit representing the transmission/reception state of image information. Electronic information includes an image file, but is not limited to this and includes various data such as document data and CG data. The first insertion/removal portion may be equipped with a port such as a USB port, and connected to a digital still camera or another storage device instead of the first recording medium.

As is apparent from the above description, the present invention can provide a user-friendly information processing apparatus capable of transferring electronic information from one recording medium to another recording medium while maintaining versatility of enabling connection to an external device.

The above and many other objects, features and advantages of the present invention will become manifest to those skilled in the art upon making reference to the following detailed description and accompanying drawings in which a preferred embodiment incorporating the principle of the present invention is shown by way of illustrative example.

### BRIEF DESCRIPTION OF THE DRAWINGS

FIG. 1 is a perspective view showing an external MO drive apparatus as a preferred embodiment of an information processing apparatus according to the present invention;

FIG. 2 is a functional block diagram showing the external MO drive apparatus in FIG. 1;

FIG. 3 is a flow chart showing control operation of a control unit 16; and

FIGS. 4A and 4B are views showing display examples of a monitor 19.

### DETAILED DESCRIPTION OF THE PREFERRED EMBODIMENT

A preferred embodiment of the present invention will be described below with reference to the accompanying drawings.

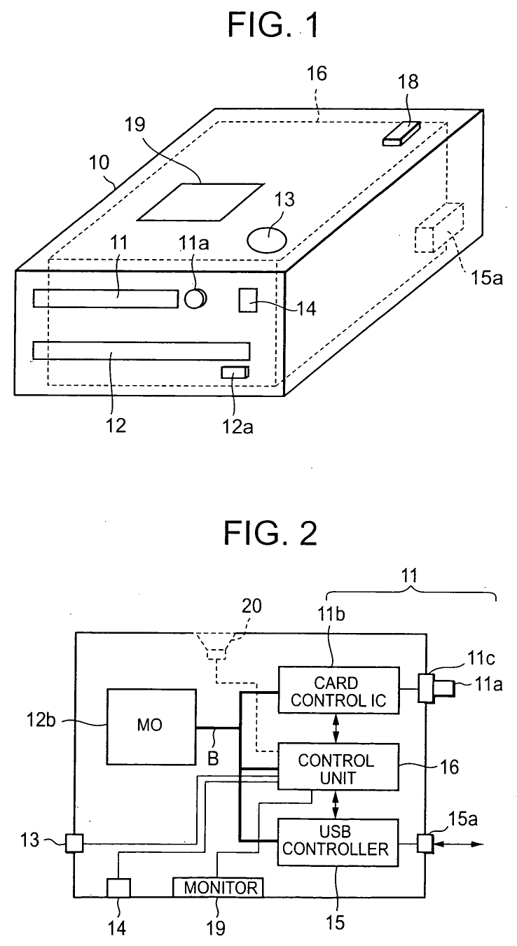

In FIG. 1 showing an external MO drive apparatus as an embodiment of an information processing apparatus according to the present invention, the front surface of a housing 10 is equipped with a PC card slot 11 serving as the first insertion/removal portion, an MO disk slot 12 serving as the second insertion/removal portion, and an LED 14 serving as a display unit. The back surface of the housing 10 is equipped with a USB connector 15a serving as a connection portion. The upper surface of the housing 10 is equipped with a monitor 19 serving as an expression unit (e.g., a display device), a copy button 13 serving as an operating member, and a power switch 18. An eject button 11a for ejecting an inserted memory card (e.g., PC card) with an adaptor is arranged on the side of the PC card slot 11. An eject button 12a for ejecting an inserted MO disk is arranged below the MO disk slot 12. A control unit 16 receives an ON signal from the copy button 13 to detect that the copy button 13 has been operated.

FIG. 2 is a functional block diagram showing the external MO drive apparatus. The control unit 16 is connected, via bus B so as to be able to transfer information, to the PC card slot 11 (including a PC card connector 11c and card control IC 11b) capable of reading out or writing electronic information from or in a memory card with an adaptor when the memory card is inserted, and a USB controller 15 having the USB connector 15a. The control unit 16 receives a signal from the copy button 13, and controls information display on the monitor 19.

The control unit 16 has a function of detecting that a memory card is inserted into the PC card slot 11 and electronic information can be read out from or written in the memory card, detecting that an MO disk is inserted into the MO disk slot 12 and electronic information can be read out from or written in the MO disk, detecting whether the USB controller 15 is connected via a cable to an external device such as a personal computer, and controlling exchange of electronic information between the PC card slot 11 and the MO disk slot 12.

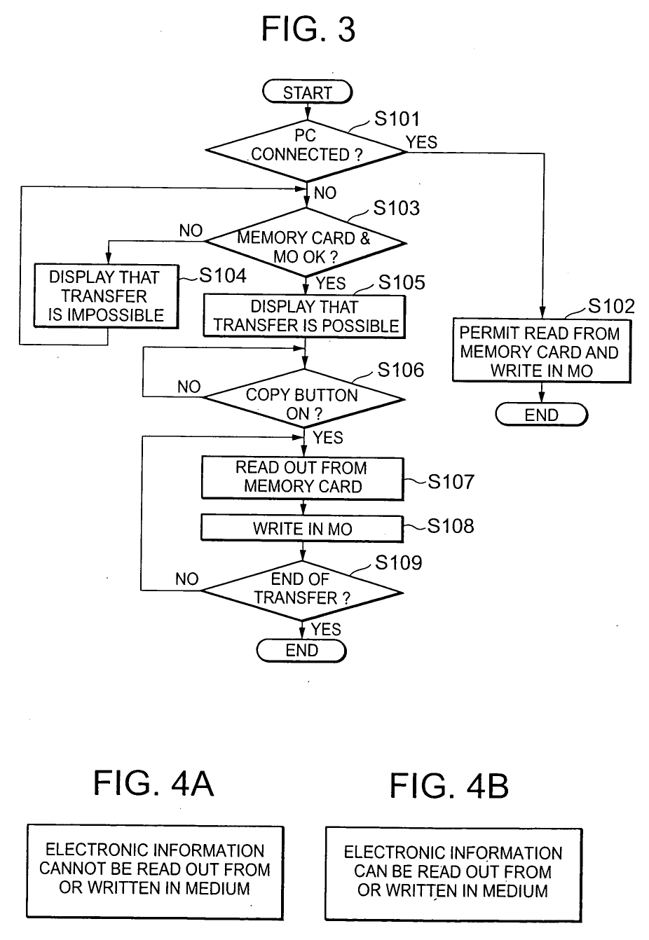

FIG. 3 is a flow chart showing control operation of the control unit 16. FIGS. 4A and 4B are views showing display examples of the monitor 19.

In step S101 of FIG. 3, the control unit 16 determines whether the external MO drive apparatus is connected to an external personal computer via the USB controller 15. If YES in step S101, the control unit 16 permits in step S102 read or write of electronic information from or in a memory card in the PC card slot 11 or an MO disk in the MO disk slot 12 via the USB controller 15 under the control of the external personal computer. That is, the external MO drive apparatus operates as an original external storage device apparatus. In this case, even an operation to the copy button 13 is ignored, and no file is directly transferred from the memory card to the MO disk.

If NO in step S101 and the control unit 16 detects in step S103 that a memory card with an adaptor is not inserted in the PC card slot 11 or even if inserted, does not allow read or write of electronic information, or an MO disk is not inserted in the MO disk slot 12 or even if inserted, does not allow read or write of electronic information, the control unit 16 causes in step S104 the monitor 19 to display a message (see FIG. 4A) that electronic information cannot be transferred, and returns the flow to step S103. At this time, even if the copy button 13 is pressed, the control unit 16 ignores the signal.

If the control unit 16 detects in step S103 that a memory card with an adaptor has been inserted in the PC card slot 11 and allows read or write of electronic information, and an MO disk has been inserted in the MO disk slot 12 and allows read or write of electronic information, the control unit 16 causes in step S105 the monitor 19 to display a message (see FIG. 4B) that electronic information can be transferred.

In step S106, the control unit 16 waits until the copy button 13 is pressed. If the user presses (operates) the copy button 13, the control unit 16 recognizes that the signal is valid, reads out electronic information from the memory card in step S107, and writes the electronic information in the MO disk in step S108, thereby transferring the electronic information. During transfer, the LED 14 flickers to warn the user not to remove the memory card or MO disk because the electronic information is being transferred. Even if the copy button 13 is operated during transfer, the control unit 16 inhibits ejection of the memory card or MO disk by ignoring the operation or issuing to the MO drive apparatus a command which makes the eject button invalid, thereby preventing malfunction. Even if the control unit 16 detects that the external MO drive apparatus has been connected to an external personal computer via the USB controller 15 during write of electronic information in the MO disk, the control unit 16 inhibits exchange of electronic information with the personal computer till the end of writing electronic information in the MO disk, thus suppressing malfunction based on an instruction from the personal computer. If the control unit 16 determines the completion of transfer in step S106, the control unit 16 ends control operation.

According to the embodiment, if the control unit 16 detects that a memory card with an adaptor is not inserted in the PC card slot 11 or even if inserted, does not allow read or write of electronic information, or an MO disk is not inserted in the MO disk slot 12 or even if inserted, does not allow read or write of electronic information, the control unit 16 causes the monitor 19 to display a message that electronic information cannot be transferred. The user sees (visually recognizes) the display, can grasp at a glance that electronic information cannot be transferred at present, and can understand that even a press to the copy button 13 does not start transfer.

If the control unit 16 detects that a memory card with an adaptor has been inserted in the PC card slot 11 and allows read or write of electronic information, and an MO disk has been inserted in the MO disk slot 12 and allows read or write of electronic information, the control unit 16 causes the monitor 19 to display a message that electronic information can be transferred. The user sees the display, can grasp at a glance that electronic information can be transferred at present, and can understand that a press to the copy button 13 starts transfer. In the embodiment, both a case in which transfer of electronic information is impossible and a case in which it is possible are displayed. However, one display suffices to allow the user to grasp the current state. Instead of display on the monitor 19 serving as a display device, the LED 14 may be flickered to express that electronic information cannot be transferred, or the LED 14 may be kept flickered to express that electronic information can be transferred. In this case, the LED 14 functions as a display device.

As another embodiment, as represented by the dotted line in FIG. 2, a loudspeaker 20 may be installed as a sound generating device serving as an expression unit. In this case, a long sound may be generated once when electronic information can be transferred, and a short sound may be generated a plurality of number of times when electronic information cannot be transferred. Alternatively, messages as shown in FIGS. 4A and 4B may be expressed by voice. The user can auditorily recognize these states.

The present invention has been described by referring to the embodiment shown in the accompanying drawings. However, the present invention should not be restrictively interpreted to the above embodiment, and can be properly changed and modified. For example, the memory card may be directly inserted into the external MO drive apparatus without the mediacy of any adaptor. With different expressions, the control unit 16 may make the user recognize whether a memory card with an adaptor has been inserted in the PC card slot 11 and if inserted, allows read or write of electronic information, or an MO disk has been inserted in the MO disk slot 12 and if inserted, allows read or write of electronic information. Further, a message may be expressed to the user by using a video/audio output unit, an external monitor as a display device, and an external loudspeaker as a sound generating device.

What is claimed is:

1. An information processing apparatus having a first insertion/removal portion capable of inserting/removing a first recording medium and at least reading out electronic information from the inserted first recording medium, a second insertion/removal portion capable of inserting/removing a second recording medium and reading out and writing electronic information from and in the inserted second recording medium, and an operating member which is connected to the first and second insertion/removal portions so as to be able to exchange electronic information and starts an operation of reading out electronic information recorded on the first recording medium and writing the electronic information in the second recording medium, comprising:
control means for controlling exchange of electronic information in the information processing apparatus; and
expression means for expressing an operation state of the information processing apparatus,
wherein when a state in which a recording medium is inserted into at least one of the first and second insertion/removal portions and electronic information can be read out or written is detected, said expression means performs expression operation of the state.

2. An information processing apparatus having a first insertion/removal portion capable of inserting/removing a first recording medium and at least reading out electronic information from the inserted first recording medium, a second insertion/removal portion capable of inserting/removing a second recording medium and reading out and writing electronic information from and in the inserted second recording medium, and an operating member which is connected to the first and second insertion/removal portions so as to be able to exchange electronic information and starts an operation of reading out electronic information recorded on the first recording medium and writing the electronic information in the second recording medium, comprising:
control means for controlling exchange of electronic information in the information processing apparatus; and
expression means for expressing an operation state of the information processing apparatus,
wherein when a state in which electronic information cannot be read out from or written in a recording medium inserted in at least one of the first and second insertion/removal portions is detected, said expression means performs expression operation of the state.

3. An apparatus according to claim 1, wherein said expression means includes a display device, and the expression operation includes transfer of a visual message to a user.

4. An apparatus according to claim 2, wherein said expression means includes a display device, and the expression operation includes transfer of a visual message to a user.

5. An apparatus according to claim 3, wherein the display device includes a monitor which displays a message.

6. An apparatus according to claim 4, wherein the display device includes a monitor which displays a message.

7. An apparatus according to claim 3, wherein the display device includes an LED.

8. An apparatus according to claim 4, wherein the display device includes an LED.

9. An apparatus according to claim 1, wherein said expression means includes a sound generating device, and the expression operation includes transfer of an auditory message to a user.

10. An apparatus according to claim 2, wherein said expression means includes a sound generating device, and the expression operation includes transfer of an auditory message to a user.

11. An apparatus according to claim 9, wherein the sound generating device includes a loudspeaker.

12. An apparatus according to claim 10, wherein the sound generating device includes a loudspeaker.

13. An apparatus according to claim 1, wherein
the operating member is operated to output to said control means a signal for starting the operation of reading out electronic information recorded on the first recording medium and writing the electronic information in the second recording medium, and
said control means ignores the signal from the operating member until said control means detects that a recording medium is inserted into at least one of the first and second insertion/removal portions and electronic information can be read out or written.

14. An apparatus according to claim 2, wherein
the operating member is operated to output to said control means a signal for starting the operation of reading out electronic information recorded on the first recording medium and writing the electronic information in the second recording medium, and
said control means ignores the signal from the operating member until said control means detects that a recording medium is inserted into at least one of the first and second insertion/removal portions and electronic information can be read out or written.

15. An apparatus according to claim 1, wherein
the operating member is operated to output to said control means a signal for starting the operation of reading out electronic information recorded on the first recording medium and writing the electronic information in the second recording medium, and
said control means ignores the signal from the operating member after said control means detects that a recording medium is inserted into at least one of the first and second insertion/removal portions and electronic information cannot be read out or written.

16. An apparatus according to claim 2, wherein
the operating member is operated to output to said control means a signal for starting the operation of reading out electronic information recorded on the first recording medium and writing the electronic information in the second recording medium, and
said control means ignores the signal from the operating member after said control means detects that a recording medium is inserted into at least one of the first and second insertion/removal portions and electronic information cannot be read out or written.
